(19) United States
(12) Patent Application Publication
(10) Pub. No.: US 2009/0204776 A1
(43) Pub. Date: Aug. 13, 2009

(54) SYSTEM FOR SECURING AN ACCESS TO FLASH MEMORY DEVICE AND METHOD FOR THE SAME

(75) Inventor: Ju-peng Chen, Taipei City (TW)

Correspondence Address: KIRTON AND MCCONKIE, 60 EAST SOUTH TEMPLE,, SUITE 1800, SALT LAKE CITY, UT, 84111, US

(73) Assignee: GENESYS LOGIC, INC., Shindian City (TW)

(21) Appl. No.: 12/061,926

(22) Filed: Apr. 3, 2008

(30) Foreign Application Priority Data
Feb. 13, 2008 (TW) 097104934

(51) Int. Cl. G06F 12/00

(52) U.S. Cl. 711/163; 711/E12.001

(57) ABSTRACT

A system for securing an access to a flash memory is provided. The system includes a first flash memory storage device having a plurality of storage elements for storing data, and a host for accessing the first flash memory storage device. The host includes a control unit, a storing unit, and an identification unit. The control unit is used for generating an identification code and assigning the identification code into a random storage element selected from the plurality of storage elements, when the first flash memory storage device is to be accessed by the host at the first time. The storing unit is used for storing the identification code and a set address corresponding to the stored storage element. The identification unit is used for examining whether the set address complies with the storage element address to be stored the identification code of the first flash memory storage device, and whether the identification code stored in the storing unit complies with an identification code of another flash memory storage device, when the first flash memory storage device is not to be accessed by the host at the first time.

### RELATED APPLICATIONS

This application claims priority to Taiwan Patent Application Serial Number 097104934, filed Feb. 13, 2008, which is herein incorporated by reference.

### BACKGROUND OF THE INVENTION

1. Field of the Invention

The present invention relates to a storage system having a flash memory, and more particularly, to a storage system and related method capable of securing an access to a flash memory and related method.

2. Description of the Related Art

Flash Memory, a non-volatile memory, may keep the previously written stored data upon shutdown. In contrast to other storage media, e.g. hard disks, soft disks, magnetic tapes and so on, the flash memory has advantages of small volume, light weight, vibration-proof, low power consumption, and no mechanical movement delay in data access; therefore, are for wide use as storage media in consumer electronic devices, embedded systems, or portable computers.

There are two kinds of flash memory: one is an NOR flash memory and the other is an NAND flash memory. An NOR flash memory is characteristically of low driving voltage, fast access speed, high stability, and are widely applied in portable electrical devices and communication devices such as Personal Computers (PCs), mobile phones, personal digital assistances (PDAs), and set-top boxes (STBs). An NAND flash memory is specifically designed as data storage media, for example, a Secure Digital (SD) memory card, a Compact Flash (CF) card, a Memory Stick (MS) card. Upon writing, erasing and reading, charges move across a floating gate relying on charge coupling which determines a threshold voltage of a transistor under the floating gate. In other words, in response to an injection of electrons into the floating gate, the logical status of the floating gate turns from 1 to 0; on the contrary, in response to a move of electrons away from the floating gate, the logical status of the floating gate turns from 0 to 1.

The NAND flash memory contains a plurality of blocks, each block having a plurality of pages and each page dividing into a data area and a spare area. The data area may have 512 bytes used for storing data. The spare area is used for storing error correction code (ECC). However, the flash memory may fail to change data update-in-place, that is, prior to writing data into a non-blank page, erasing a block including the non-blank page is required. In general, erasing a block takes as much time as 10-20 times greater than writing into a page. If a size of written data is over an assigned block, the filled pages in the assigned block may have to be removed to other blocks, and then erasing the assigned block is performed.

Furthermore, flash memory blocks may fail to be accessed when in excess of one million times of erasures before the block is considered to be worn out. This is because the number of erasure times for a block is close to one million times, charge within the floating gate may be insufficient due to current leakage of realized capacitor, thereby resulting in data loss of the flash memory cell, and even a failure of access to the flash memory. In other words, if erased over a limited times, a block may be unable to be accessed.

Therefore, a system of use of managing an access to the flash memory is very essential. Traditionally, the present file systems for managing access to the flash memory include Microsoft FFS, JFFS2, YAFFS and so on. These specific file systems have more efficiency in access the flash memory, yet only incorporate with storage media using the flash memory. The other way is to employ a Flash Translation Layer (FTL), which simulates the flash memory as a hard disk. In doing so, the upper layer of the FTL may use a normal file system, such as FAT32 or EXT3, to write/read sectors at the lower layer to access to the flash memory by means of FTL. FTL creates a logical-physical address table which records information relating to the logical block addresses (LBA) mapping to the physical block addresses (PBA). Despite the use of FTL may simplify management of access to flash memory and choose the upper file system, longer access time period and greater memory occupation are required on account of translations of all requests by means of FTL. For instance, provided that a number of ten consecutive requests, each of writing 2K bytes, are to be written into a block, the block is duplicated repeatedly by 10 times. That wastes much time.

Owing to an increasing demand for the flash memory embedded in various electronics devices such as digital cameras and MP3 players, creators of digital context, producers for such electronics devices, and the users, have paid more concerns on data security. As with a rapid development of hardware or software, data duplication becomes easier because data duplication cost has gradually lowered. Therefore, it is necessary to develop a system that secures an access to the flash memory.

### SUMMARY OF THE INVENTION

It is therefore an object of the present invention to provide a storage system having a flash memory and capable of securing an access to the flash memory, and related method thereof.

Briefly summarized, the claimed invention provides a system for securing an access to a flash memory. The system comprises a first flash memory storage device having a plurality of storage elements for storing data, and a host for accessing the first flash memory storage device. The host comprises a control unit, a storing unit, and an identification unit. The control unit is used for generating an identification code and assigning the identification code into a random storage element selected from the plurality of storage elements, when the first flash memory storage device is to be accessed by the host at the first time. The storing unit is used for storing the identification code and a set address corresponding to the stored storage element. The identification unit is used for examining whether the set address complies with the storage element address to be stored the identification code of the first flash memory storage device, and whether the identification code stored in the storing unit complies with an identification code of another flash memory storage device, when the first flash memory storage device is not to be accessed by the host at the first time.

According to the present invention, a method for securing an access to a flash memory storage device having a plurality of storage elements for storing data is disclosed. The method comprises the following steps: (a)generating an identification code when the first flash memory storage device is to be accessed at the first time; (b)assigning the identification code into a random storage element selected from the plurality of storage elements; (c) storing the identification code and a set address corresponding to the stored storage element; (d) examining whether the set address complies with the storage element address to be stored the identification code of the flash memory storage device when the flash memory storage device is not to be accessed at the first time; and (e) examining whether the stored identification code complies with the identification code of the flash memory storage device after step (d).

The present invention will be described with reference to the accompanying drawings, which show exemplary embodiments of the present invention.

### BRIEF DESCRIPTION OF THE DRAWINGS

FIG. 1 illustrates a block diagram of a storage system according to a preferred embodiment of the present invention.

FIG. 2 depicts a flowchart of the method according to the present invention.

### DETAILED DESCRIPTION OF THE INVENTION

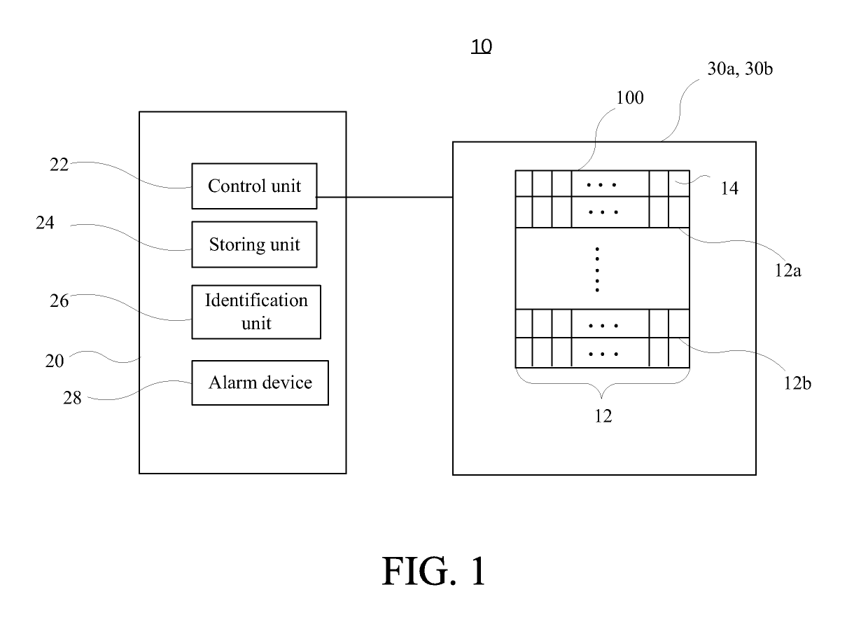

Referring to FIG. 1 illustrating a block diagram of a storage system 10 according to a preferred embodiment of the present invention, the storage system 10 comprises a host 20 and a flash memory storage device 30. The host 20 may be a desktop computer, a notebook computer or a recordable DVD player. The host 20 comprises a control unit 22, a storing unit 24, and an identification unit 26. The flash memory storage device 30 comprises a flash memory 100. In this embodiment, the flash memory 100 is divided as a plurality of storage elements 12 having multiple blocks 14, and each block 14 is composed of 64 pages. Each page is divided into a data area and a spare area. The data area which may have 512 bytes is used for storing data. The spare area is used for storing error correction code (ECC). The storing unit 24 may be implemented by a part of memory within the host 20, such as Dynamic Random Access Memory (DRAM), Static Random Access Memory (SRAM). The control unit 22 and the identification unit 26 may be implemented by software program code embedded in the memory. The flash memory storage device 30 may be a Secure Digital/Multi Media Memory card (SD/MMC) memory card, a Compact Flash/Micro Drive (CF/MD) memory card, a Memory Stick (MS) memory card, a Smart Media (SM) memory card, an extreme Digital (XD) memory card or the like.

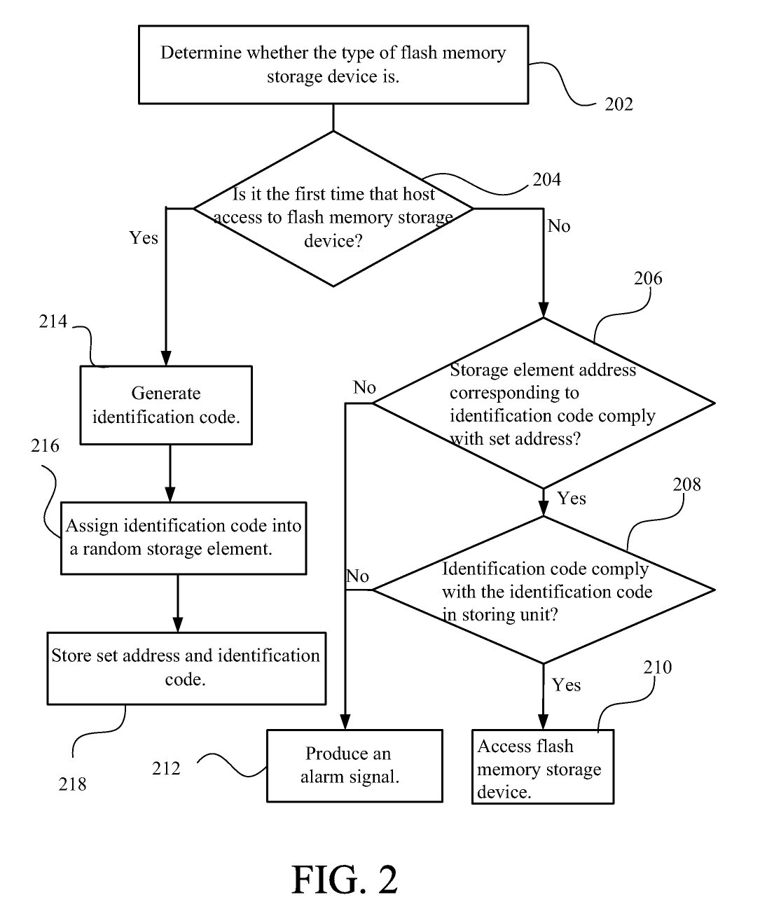

Please refer to FIG. 1 in conjunction to FIG. 2 depicting a flowchart of the method according to the present invention. Once a first flash memory storage device 30a links to the host 20, the identification unit 26 determines whether the type of the first flash memory storage device 30a is stored in the storing unit 24 (Step 202). Then, the identification unit 26 determines whether it is the first time that the host 20 accesses to the first flash memory storage device 30a (Step 204). If the first flash memory storage device 30a is accessed at the first time by the host 20, indicating that no information relating to the first flash memory storage device 30a is being stored in the storing unit 24. Thereafter, the control unit 22 generates a first identification code (Step 214), and assigns the first identification code into a random storage element 12a selected from the plurality of storage elements 12 of the first flash memory storage device 30a (Step 216). In the meantime, the control unit 22 sets the address of the storage element 12a as a first set address, and then the first set address and the first identification code are stored in the storing unit 24 (Step 218). It is appreciated that the first flash memory storage device 30a has a unique identification code corresponding to one host 20.

Afterwards, the host 20, at the first time, electrically connects and accesses a second flash memory storage device 30b whose circuitry is the same as the first flash memory storage device 30a but the type is not identical, the control unit 22 generates a second identification code in response to a fact that no information relating to the second flash memory storage device 30b is being stored in the storing unit 24. Thereafter, the control unit 22 assigns the second identification code into another random storage element 12b selected from the plurality of storage elements 12 of the first flash memory storage device 30b. In the meantime, the control unit 22 sets the address of the storage element 12b as a second set address, and then the second set address and the second identification code are stored in the storing unit 24. When the first flash memory storage device 30b links to the host 20 again, the identification unit 26 determines that the type of the first flash memory storage device 30a was read before. Then, the identification unit 26 compares its identification code and an storage element address corresponding to the identification code with the first identification code and the first set address in the storing unit 24, respectively (Step 206). If the two criteria are satisfied, the first identification code is thus read from the storage element 12a; if not, an alarm device 28 produces an alarm signal (Step 212). Accordingly, the identification unit 26 is capable of quickly confirming whether the identification code matches the first identification code stored in the storing unit 24 (Step 208). If the identification code matches the first identification code stored in the storing unit 24, the host 20 can access other data, e.g. video files or audio files, stored in the first flash memory storage device 30a (Step 210). Conversely, if the identification code does not match the first identification code stored in the storing unit 24, the alarm device 28 produces an alarm signal. In this embodiment, the alarm device 28 may be a light for twinkling based on the alarm signal, or an audio device for making noises based on the alarm signal.

Despite another host links to the first flash memory storage device 30a, it fails to store a third identification code into the first flash memory storage device 30a because one flash memory storage device has a unique identification code. In addition, the identification unit 26 in another host does not assure the set address of the storage element storing the identification code, such that only the host 20 communicating with the flash memory storage device 30a at the first time is authorized to access the flash memory storage device 30a by identifying the stored identification code and the storage element address corresponding to the identification code.

In contrast to prior art, the present inventive system in which the flash memory storage device identifies a unique identification code which is generated in response to a first time connection to a host, and stores such identification code into a random storage element selected from a plurality of storage elements of the flash memory storage device. In doing so, only the host is authorized to access the flash memory storage device by identifying the stored identification code and the storage element address corresponding to the identification code, thereby resolving the problem of data duplication.

While the present invention has been described in connection with what is considered the most practical and preferred embodiments, it is understood that this invention is not limited to the disclosed embodiments but is intended to cover various arrangements made without departing from the scope of the broadest interpretation of the append claims.

What is claimed is:

1. A system for securing an access to a flash memory comprising:
a first flash memory storage device having a plurality of storage elements for storing data; and
a host for accessing the first flash memory storage device, comprising:
a control unit for generating an identification code and assigning the identification code into a random storage element selected from the plurality of storage elements when the first flash memory storage device is to be accessed by the host at the first time;
a storing unit for storing the identification code and a set address corresponding to the stored storage element; and
an identification unit for examining whether the set address complies with the storage element address to be stored in the identification code of the first flash memory storage device, and whether the identification code stored in the storing unit complies with an identification code of another flash memory storage device when the first flash memory storage device is not to be accessed by the host at the first time.

2. The system as claimed in claim 1, wherein the host further comprises a memory, and the control unit is a software program code stored in the memory.

3. The system as claimed in claim 1, wherein the host further comprises a memory, and the identification unit is a software program code stored in the memory.

4. The system as claimed in claim 1, wherein the flash memory storage device is selected from a group consisting of a Secure Digital/Multi Media Memory card (SD/MMC) memory card, a Compact Flash/Micro Drive (CF/MD) memory card, a Memory Stick (MS) memory card, a Smart Media (SM) memory card, an eXtreme Digital (XD) memory card.

5. The system as claimed in claim 1, wherein the host further comprises an alarm device for producing an alarm signal when the set address fails to comply with the storage element address to be stored in the identification code of a second flash memory storage device, or when the identification code stored in the storing unit fails to comply with an identification code of the second flash memory storage device.

6. The system as claimed in claim 5, wherein the alarm device is a light for twinkling when the set address fails to comply with the storage element address to be stored in the identification code of a second flash memory storage device, or when the identification code stored in the storing unit fails to comply with an identification code of the second flash memory storage device.

7. The system as claimed in claim 5, wherein the alarm device is an audio device for making noise when the set address fails to comply with the storage element address to be stored the identification code of a second flash memory storage device, or when the identification code stored in the storing unit fails to comply with an identification code of the second flash memory storage device.

8. A method for securing an access to a flash memory storage device having a plurality of storage elements for storing data, the method comprising:
(a) generating an identification code when the first flash memory storage device is to be accessed at the first time;
(b) assigning the identification code into a random storage element selected from the plurality of storage elements;
(c) storing the identification code and a set address corresponding to the stored storage element;
(d) examining whether the set address complies with the storage element address to be stored in the identification code of the flash memory storage device, when the flash memory storage device is not to be accessed at the first time; and
(e) examining whether the stored identification code complies with the identification code of the flash memory storage device after step (d).

9. The method as claimed in claim 8, wherein the flash memory storage device is selected from a group consisting of a Secure Digital/Multi Media Memory card (SD/MMC) memory card, a Compact Flash/Micro Drive (CF/MD) memory card, a Memory Stick (MS) memory card, a Smart Media (SM) memory card, an extreme Digital (XD) memory card.

10. The method as claimed in claim 8, further comprising:
producing an alarm signal when the set address fails to comply with a storage element address to be stored an identification code of another flash memory storage device;

11. The method as claimed in claim 8, further comprising:
producing an alarm signal when the identification code stored in the storing unit fails to comply with an identification code of another flash memory storage device.
